(19) United States
(12) Patent Application Publication
(10) Pub. No.: US 2018/0073643 A1
(43) Pub. Date: Mar. 15, 2018

(54) IMPROVED SHEAR SEAL ASSEMBLY

(71) Applicant: Proserv Operations, Inc., Houston, TX (US)

(72) Inventor: Preston WEINTRAUB, Spring, TX (US)

(21) Appl. No.: 15/705,036

(22) Filed: Sep. 14, 2017

Related U.S. Application Data
(60) Provisional application No. 62/394,801, filed on Sep. 15, 2016.

(51) Int. Cl. F16K 3/24

(52) U.S. Cl. CPC F16K 3/243; F16K 3/26

(57) ABSTRACT

A seal assembly includes a first sealing element, a second sealing element, a pin member, and a sealing ring. The first sealing element has a recess formed therein and the second sealing element has a recess formed therein. The pin member has a first end portion and a second end portion. The end of the pin member is located within the recess of the first sealing element and the second end portion of the pin member is located within the recess of the second sealing element. The pin member is movable within the recesses of the first and second sealing elements. The sealing ring is located within a channel.

### CROSS-REFERENCE TO RELATED APPLICATIONS

This application claims benefit of U.S. provisional patent application Ser. No. 62/394,801, filed Sep. 15, 2016, which is herein incorporated by reference.

### BACKGROUND

### Field of the Disclosure

Embodiments of the present disclosure generally relate to a seal assembly, and more specifically, to an improved shear seal assembly.

### Background of the Disclosure

Shear seal assemblies (also referred to as bi-directional seal assemblies) function to selectively position one or more openings in a seal carrier into or out of alignment with a flow passage in a valve or other device such as a pressure regulator, to thereby selectively allow fluid communication through the carrier to an additional opening exposed to the opening in the carrier. Shear seal assemblies also function to selectively expose openings in a valve to allow, or prevent, fluid from passing through the openings.

For example, a shear seal assembly can be used in a fluid valve positioned in a downhole tool that is used for sampling wellbore fluids. When inserting the downhole tool in the wellbore, the fluid valve is typically in a closed position. Because external pressures in a wellbore often exceed 20,000 psi absolute, the shear seal assembly must be capable of maintaining sealing contact with the opposed seal plates of the fluid valve while exposed to these levels of external pressures in a wellbore. When the downhole tool reaches a desired depth in the wellbore that has wellbore fluid needing to be sampled, a pilot valve within the fluid valve can be pulsed to cause a seal carrier to slide the shear seal assembly along the opposed seal plates to open the valve inlet ports. This allows wellbore fluids to enter the inlet ports of the fluid valve, pass through the longitudinal passageway of the valve, and exit the fluid valve to a sample collection bottle via a function port. After a sample has been collected, another pilot valve is pulsed, causing the seal carrier to move back to the closed position. As the downhole tool is brought back to the surface, external pressure drops to atmospheric pressure, but the pressure inside the sample collection bottle and the valve remains at wellbore pressure, which may be in excess of 20,000 psi absolute. The shear seal assembly must therefore be able to maintain sealing capacity when pressure acts on it via wellbore fluid passing through the shear seal assembly's inlet ports and/or when pressure acts on it from below because of the pressure within the sample collection bottle or the valve. One such sample collection valve is shown and described in U.S. Pat. No. 9,423,031.

In some instances, a shear seal assembly within a valve may fail to maintain sealing capacity with the seal plates of a valve as the shear seal assembly shifts between a closed positon and an open position because the sealing elements in the shear seal assembly may back off of the seal plates against which they are intended to seal. Moreover, in other instances, a shear seal assembly within a valve may fail to maintain sealing capacity with the seal plates because the shear seal assembly is exposed to a source of non-uniform pressure, such that one portion of the shear seal assembly is exposed to a greater pressure than another portion of the shear seal assembly. Accordingly, an improved shear seal assembly is desirable that is capable of maintaining sealing capacity in these various instances.

Additionally, in a shear seal style valve such as that shown and described in U.S. Pat. No. 9,423,031, a pair of opposed seal elements are biased apart by a key seal, and one of the pair of seal elements includes a pin integrally formed therewith and extending therefrom, and the other of the seal elements includes an opening therein into which the pin is received. The key seal surrounds the pin. In use, the seal elements are biased against opposed seal plates, each having an opening therein. In a valve closed state, the seal elements overlie the seal plates and cover the openings. In the valve open state, the seal elements only partially overlie the seal plates, and the openings therein are exposed to the interior of the valve, allowing a fluid to flow therethrough and into a sample collection bottle. Thereafter, the seal elements are returned to the position wherein they overlie the seal plates and block the openings. Because, in the valve open position, the seal elements only partially overlie the seal plates, a portion thereof are unsupported. As a result, the seal elements, in which the inner faces are normally parallel from one another, may cock and the inner faces become askew, and a bending force occurs on the end of the pin in the opening in one of the seal elements. To prevent corrosion, erosion and wear on the shear seal elements, they are commonly manufactured from a carbide material, such as tungsten carbide. Carbides have lower bending strength than materials such as stainless steel, and it has been found that a crack can form at the root of the pin as a result of the bending force, causing the pin to break off of the seal element.

### SUMMARY

One embodiment of the present disclosure relates to a shear seal assembly positioned in a transverse bore of a seal carrier in a valve. The valve includes a pair of opposed seal plates having openings therein. The seal carrier is capable of moving from a closed position wherein one or more openings in adjacent seal plates are blocked off, and open position wherein the openings in adjacent seal plates are exposed to the interior of the valve. The shear seal assembly fully overlies the seal plates when the seal carrier is in the closed position and the shear seal assembly only partially overlies the seal plates when the seal carrier is in the open position, thereby exposing the openings in the seal plates. The shear seal assembly includes a pin member, first and second sealing elements, and a sealing ring. The pin member includes a first end portion and a second end portion. The first sealing element is in contact with and seals against one seal plate, and the second sealing element is in contact with and seals against the other seal plate. Each of the first and second sealing elements includes a recess. The first end portion of the pin member extends inwardly of the recess of the first sealing element and the second end portion of the pin member extends inwardly of the recess of the second sealing element such that a middle portion of the pin member is positioned between the first and second sealing elements. A sealing ring is disposed between and contacts the first and second sealing elements. The sealing ring circumscribes a portion of the pin member.

Another embodiment of the present disclosure relates to a shear seal assembly positioned in a transverse bore of a seal carrier in a valve. The valve includes a pair of opposed seal plates. The seal carrier is capable of moving between a closed position wherein one or more openings in adjacent seal plates are blocked off and an open position wherein the openings are exposed inwardly of the valve. The shear seal assembly fully overlies the seal plates and blocks the openings when the seal carrier is in the closed position and the shear seal assembly partially overlies the seal plates and exposes the openings to the interior of the valve when the seal carrier is in the open position. The shear seal assembly includes a pin member, first and second sealing elements, and a sealing ring. The first sealing element has a block section, a pin section, and a bore therein. The pin section extends from the block section. The bore of the first sealing element extends through the block section and the pin section. The block section is in contact with and sealing against one seal plate. The second sealing element has a bore therein. The bore of the second sealing element receives at least a portion of the pin section of the first sealing element therein. The second sealing element is in contact with, and seals against, the other seal plate. The sealing ring is disposed between, and contacts, the first and second sealing elements. The sealing ring circumscribes a portion of the pin section of the first sealing element. In an alternate construct, the pin is provided as a separate element, and each of the sealing elements include a recess into which the pin extends, and an opening therethrough in fluid communication with the bore extending through the pin.

Yet another embodiment of the present disclosure provides a seal assembly including a first sealing element, a second sealing element, a pin member, and a sealing ring. The first sealing element has a recess formed therein, with an interior wall of the first sealing element surrounding the recess therein. The second sealing element has a recess formed therein, with an interior wall of the second sealing element surrounding the recess therein. The first and second sealing elements are oriented such that the interior wall of the first sealing element faces the interior wall of the second sealing element. The pin member has a first end portion and a second end portion. The first end portion of the pin member is located within the recess of the first sealing element and the second end portion of the pin member is located within the recess of the second sealing element. The pin member is movable within the recesses of the first and second sealing elements. The interior wall of the first sealing element is spaced from the interior wall of the second sealing element to define a channel circumscribing the pin member. The sealing ring is located within the channel, with the sealing ring contacting the interior walls of the first and second sealing elements. In an alternate construct, the pin is provided as a separate element, and each of the sealing elements include a recess into which the pin extends, and an opening therethrough in fluid communication with the bore extending through the pin.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the drawings. It is to be noted, however, that the drawings illustrate only typical embodiments of this disclosure and are therefore not to be considered limiting of its scope, for the disclosure may admit to other equally effective embodiments.

FIG. 1 is a sectional view of a fluid valve with an embodiment of a shear seal assembly in accordance with the present disclosure, the valve being in a closed position.

FIG. 2 is a sectional view of the fluid valve of FIG. 1, with the valve being in an open configuration.

FIG. 3 is an enlarged sectional view of the shear seal assembly shown in FIGS. 1 and 2, with the shear seal assembly exposed to function pressure.

FIG. 4 is an enlarged sectional view of the shear seal assembly shown in FIGS. 1 and 2, with the shear seal assembly exposed to supply pressure.

FIG. 5 is a perspective view of a sealing ring used within the shear seal assembly shown in FIGS. 1-4.

FIG. 6 is a sectional view of the sealing ring shown in FIG. 5.

FIG. 7 is an enlarged sectional view of an alternative embodiment of a shear seal assembly in accordance with the present disclosure, with the shear seal assembly being disposed in a fluid valve exposed to function pressure.

FIG. 8 is an enlarged sectional view of the shear seal assembly shown in FIG. 7, with the shear seal assembly being disposed in a fluid valve exposed to supply pressure.

FIG. 9 is an enlarged sectional view of an alternative embodiment of a shear seal assembly in accordance with the present disclosure, with the shear seal assembly being in a first position within the fluid valve.

FIG. 10 is an enlarged sectional view of the shear seal assembly shown in FIG. 9, with the shear seal assembly being in a second position within the fluid valve.

While the disclosure is susceptible to various modifications and alternative forms, specific embodiments thereof are shown by way of example in the drawings and will herein be described in detail. It should be understood, however, that the drawings and detailed description presented herein are not intended to limit the disclosure to the particular embodiment disclosed, but on the contrary, the intention is to cover all modifications, equivalents, and alternatives falling within the spirit and scope of the present disclosure as defined by the claims.

### DETAILED DESCRIPTION

The present disclosure relates to embodiments of an improved shear seal assembly capable of being positioned in a transverse bore of a seal carrier of a fluid valve. The seal carrier is configured to shift from a closed position to an open position. The valve includes a pair of opposed seal plates. The embodiments of the improved shear seal assembly are aligned with the seal plates when the seal carrier is in the closed position and out of alignment with the seal plates when the seal carrier is in the open position. The shear seal assembly is provided in the valve such that it is exposed alternatively, and seals against, a higher pressure on the exterior of the valve than within the valve, and a higher pressure within the valve than exterior thereto.

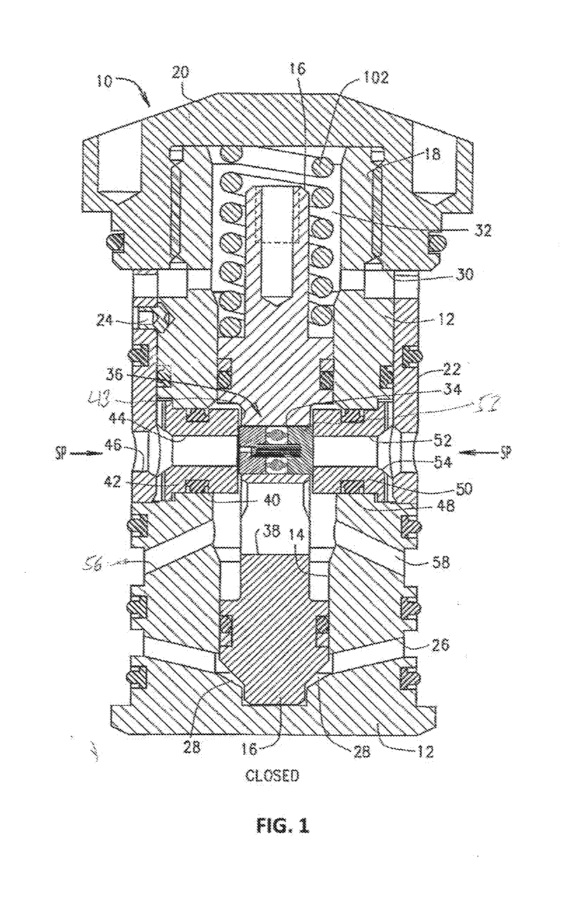

In the valve describe with respect to FIGS. 1 to 10, the valve is provided in a fluid sampling tool which is lowered into a well bore to obtain a sample of wellbore fluid at a desired wellbore depth. The pressure of the fluid in the wellbore is a function of the quantity of wellbore fluid above the sampling location, and can reach up to the order of 30,000 p.s.i. When the valve is located at the earths' surface before being lowered into the wellbore, the interior pressure within the valve and the ambient pressure surrounding the valve is atmospheric pressure. As the valve is lowered into the well bore, the pressure on the exterior of the valve increases while the interior of the valve preferably remains at atmospheric pressure, and the shear seal prevents fluid from flowing from the well bore into the interior volume thereof until sampling depth is reached. At sampling depth, the shear seal in moved to allow wellbore fluid at sampling pressure to enter the valve, and then the shear seal is moved to block off access between the wellbore and the interior of the valve. As the valve is raised out of the wellbore after one or more fluid samples are stored therein, the fluid pressure within the valve, which is at the sampled fluid pressure, exceeds the fluid pressure around the valve, and the shear seal is provided to prevent fluid at sampled pressure from leaking from the interior volume of the valve back into the wellbore.

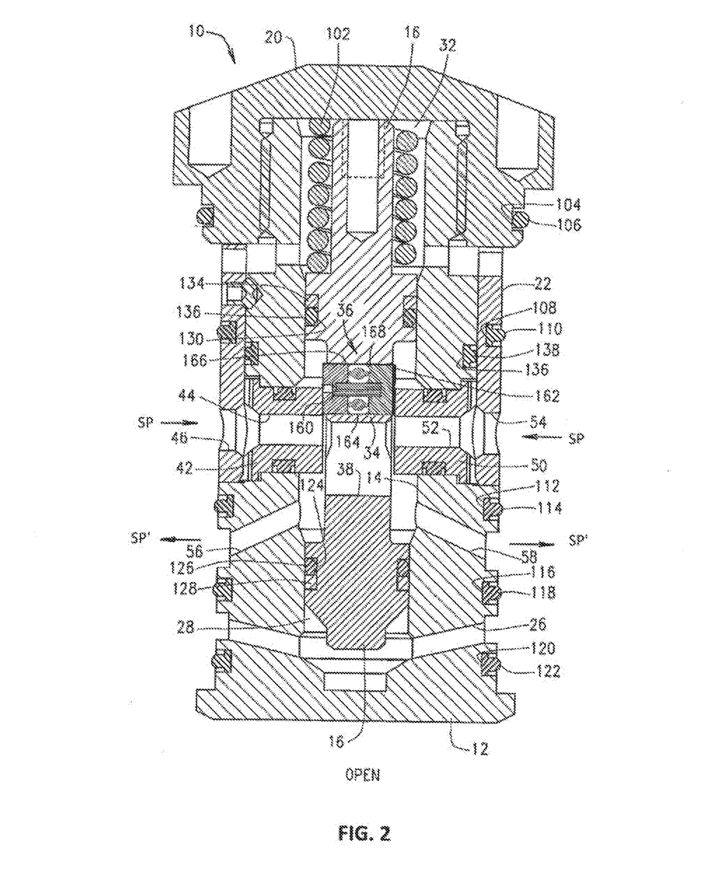

FIGS. 1-2 illustrate a shear seal assembly 36 in accordance with the present disclosure located within a fluid valve 10. The fluid valve 10 is a normally closed, two position, two-way valve. The fluid valve 10 is sometimes referred to as a “cartridge” type valve because it is often manufactured in the configuration of FIG. 1 and subsequently slipped into a valve chamber in the body of a downhole tool (not shown). The downhole tool of this embodiment has one or more fluid valves to test wellbore fluids at different well depths. Each fluid valve 10 is in fluid communication with the wellbore and one or more sample collection bottle (not shown) to hold wellbore fluids. The fluid valve 10 is typically rated for operational pressures of up to 30,000 psi and temperatures of up to 350° F.

As can be seen in FIGS. 1 and 2, the fluid valve 10 has a generally cylindrical body 12 which defines a longitudinal bore 14 sized and arranged to receive a seal carrier 16. The seal carrier 16 moves from a normally closed position illustrated in FIG. 1 to an open position illustrated in FIG. 2.

The body 12 has threads 18 formed on one end to threadably engage the cap 20. A cylinder cover 22 surrounds a portion of the body 12. The cylinder cover 22 is rotationally held in place on the body 12 by a set screw 24 and longitudinally in place by cap 20.

An O-ring groove 104 is formed in the cap 20 and is sized and arranged to receive an O-ring 106 which seals the cap 20 against the valve chamber in the downhole tool. A groove 108 is formed in the cylinder cover 22 and is sized and arranged to receive T-seal 110 which seals the cylinder cover 22 against the valve chamber in the downhole tool.

A groove 112 is formed in the body 12 and is sized and arranged to receive T-seal 114. A groove 116 is formed in the body 12 and is sized and arranged to receive T-seal 118. A groove 120 is formed in the body 12 and is sized and arranged to receive T-seal 122. T-seals 114 and 118 seal and isolate the function port 56 against the valve chamber in the downhole tool, not shown. T-seals 118 and 122 seal and isolate the pilot open port against the valve chamber in the downhole tool (not shown).

A groove 124 is formed in the seal carrier 16 and is sized and received to receive an O-ring 126 and a back-up ring 128. The O-ring 126 and backup ring 128 seal and isolate the open chamber 28 from the other flow passageways in the valve 10. A groove 130 is found in the other end of the seal carrier 16 and is sized and arranged to receive an O-ring 132 and backup ring 134. The O-ring 132 and backup ring 134 seal and isolate the close chamber 32 from the other flow passageways in the valve 10.

The body 12 includes an open pilot port 26 in fluid communication with an open chamber 28 and a close pilot port 30 in fluid communication with the close chamber 32. The close chamber 32 is defined by the longitudinal bore 14 in body 12, the cap 20, and the seal carrier 16. The open pilot port 26 is in fluid communication with a pilot open valve (not shown). The close pilot port 30 is in fluid communication with a pilot close valve (not shown). Both pilot valves are connected to a source of pressurized pilot fluid (not shown).

The seal carrier 16 has a transverse bore 34 sized and arrange to receive a shear seal assembly 36. A transverse flow passageway 38 is also formed adjacent to the seal carrier 16 to facilitate fluid flow into the valve when it is in the open position.

A first bore 40 is formed in the body 12 and is sized and arranged to receive the first seal plate 42. A through-bore 44 is formed in the first seal plate 42 and is in fluid communication with an inlet port 46 formed in the cylinder cover 22. A second bore 48 is formed in the body 12 and is sized and arranged to receive the second seal plate 50. A through-bore 52 is formed in the second seal plate 50 and is in fluid communication with an inlet port 54 formed in the cylinder cover 22.

When the downhole tool is placed in the wellbore, pressures may reach 30,000 psi, depending on the depth of the well. Wellbore fluids exert this “supply pressure” as indicated by the arrows labeled SP in FIG. 1.

To shift the valve 10 from the closed position of FIG. 1 to the open position of FIG. 2, the pilot open valve is actuated allowing pilot pressure to enter the open port 26 and the open chamber 28. The force of the pressurized pilot fluid acting on the seal carrier 16 shifts it to the open position illustrated in FIG. 2.

Referring to FIG. 2, the valve 10 is shown in the open position. When valve 10 is in the open position, wellbore fluids can flow into valve 10 in the directions indicated by the flow arrows SP such that the wellbore fluids pass through the open inlet ports 46 and 54 of the cylinder cover 22, into through-bores 44 and 52 of seal plates 42 and 50, thence into the transverse flow passage 38 and into a selected one of the functional ports 56, 58 and into a collection bottle connected thereto. Functional ports 56, 58 extend from the transverse flow passage 38 within the valve to sample collection bottles. To allow the downhole tool to collect samples at different depths within the wellbore, a plurality of such functional ports, each corresponding to a single sample collection bottle, may be provided, and each sample collection bottle can be opened and closed by a sample collection bottle valve(not shown). Alternatively, the sample collection bottle access may not be valved and is open to the transverse flow passage 38 through the functional ports 56, 58.

After a wellbore fluid sample is taken, the pilot close valve is actuated and pressurized pilot fluid enters the close port 30 and the close chamber 32. The pilot fluid is typically pressurized in the range of 1,500 to 10,000 psi. The force of this pilot fluid on the seal carrier causes it to shift from the open position of FIG. 2 to the closed position of FIG. 1. A spring 102 is positioned in the close chamber 32. A typical spring rate for the valve 10 is 261 lb/in. The spring 102 urges the seal carrier 16 into the normally closed position of FIG. 1. Then, the downhole tool can be moved to a different wellbore depth, and another sample taken and collected in a different sample bottle. This is repeated until all desired samples are taken, or all sample bottles have a fluid sample therein, after which the downhole tool is raised to the surface.

The shear seal assembly 36 is positioned in the transverse bore 34 of seal carrier 16. The shear seal assembly 36 prevents fluid flow between the transverse flow passage 38 and the through bores 44, 52 of seal plates 42, 50. Where the pressure in the transverse flow passage 38 is a that of a sample taken at a sampling depth, and the downhole tool is then raised so that the external pressure exceeds the internal pressure of the transverse flow passage 38, the shear seal assembly prevents the fluid at the sampled wellbore pressure flowing to the through bore 44 of seal plate 42 and the through bore 52 of seal plate 50. The shear seal assembly 36 also prevents higher wellbore pressure from passing through to the through bore 44 of seal plate 42 and the through bore 52 of seal plate 50 and into the transverse flow passage 38 until a sampling depth is reached and the valve is actuated to the open position. The shear seal assembly 36 is therefore referred to as “bi-directional” because it is capable of sealing when exposed to both a higher wellbore pressure than an internal pressure and a higher internal pressure than the wellbore pressure.

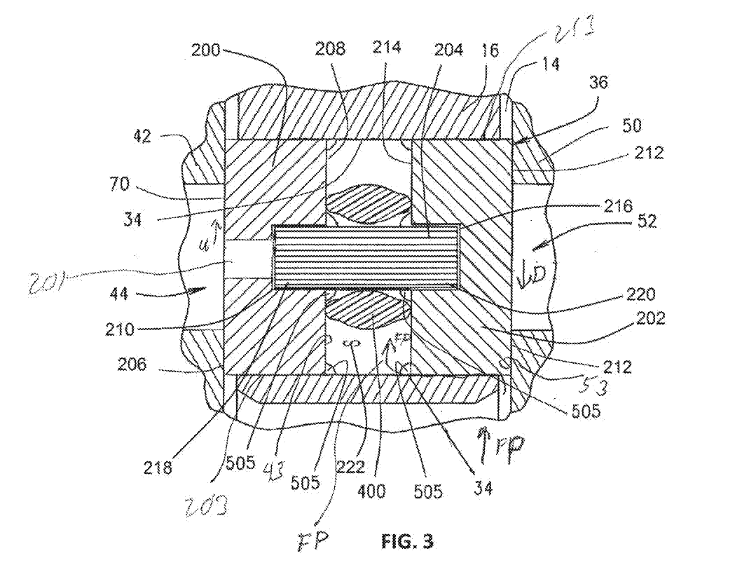

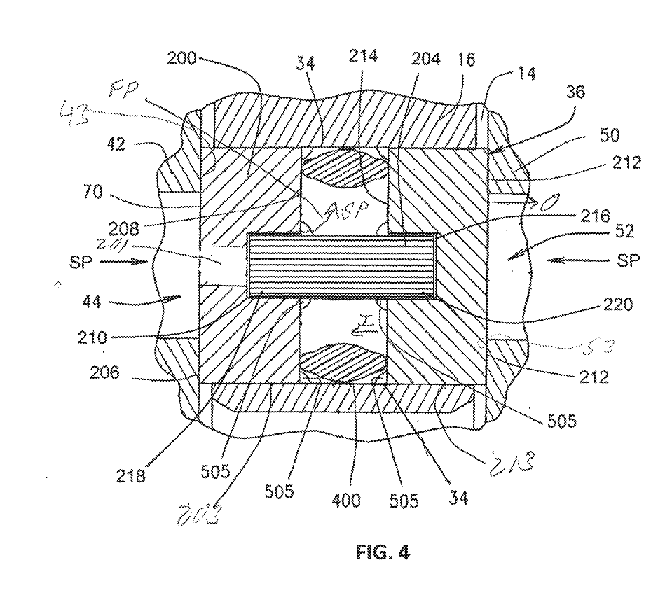

FIGS. 3 and 4 illustrate an enlarged view of the shear seal assembly 36 shown in FIGS. 1 and 2. The shear seal assembly 36 is positioned in the transverse bore 34 of the fluid valve 10. Shear seal assembly 36 includes a first sealing element 200, a second sealing element 202, a pin member 204, and a sealing ring 400.

The first sealing element 200 includes an outer circumferential surface 203, an exterior wall 206, an interior wall 208, and a recess 210 extending inwardly of, and generally centered in, the interior wall 208. A flow passage 201 extends from exterior wall 206 into the recess 210. The second sealing element 202 includes an outer circumferential surface 213, an exterior wall 212, an interior wall 214, and a recess 216 extending inwardly of, and generally centered in, the interior wall 214. The interior walls 212, 214 face each other and are spaced from one another. The interior wall 208 of the first sealing element 200 is an annular surface which surrounds the recess 210, and the interior wall 214 of the second sealing element 202 is an annular surface which surrounds the recess 216. The shear seal assembly 36 is positioned in the transverse bore 34 of the fluid valve and the sealing elements 200, 202 are outwardly biased such that the exterior wall 206 of the first sealing element 200 is in contact with and seals against a first sealing surface 43 of the seal plate 42 and the exterior wall 212 of the second sealing element 202 is in contact with and seals against a second sealing surface 53 of the seal plate 50. The first and second sealing elements 200, 202 are oriented such that interior wall 208 faces interior wall 214. The second sealing element may also include a flow passage extending from the exterior wall 212 into recess 216 thereof.

The pin member 204 includes a first end portion 218 and a second end portion 220. The first end portion 218 is located within the recess 210 and the second end portion 220 is located within the recess 216. Accordingly, the pin member 204 is disposed between the first and second sealing elements 200, 202. The pin member 204 is moveable within the recesses 210, 216 with a very small clearance therebetween on the order of 1 to 5 thousands of an inch to enable the first sealing element 200 to move relative to the second sealing element 202, and sampled fluid under pressure to communicate with the space between the interior walls 208, 214. The relative motion of the first and second sealing elements 200, 202 within the transverse bore 34 is insufficient to allow the pin member 204 to become dislodged from the recesses 210, 216. The ability of the pin member 204 to move within the recesses 210, 216 helps maintain the connection and alignment between the first and second sealing elements 200, 202 while allowing the first and second sealing elements 200, 202 to move slightly inwardly or outwardly of the transverse bore 34 without binding. The grounding of the pin member 204 against the base of the recesses 210, 216 limits the compression of a sealing ring 400. The ability of first sealing element 200 to move relative to the second sealing element 202 enables the exterior walls 206, 212 to maintain sealing contact with the first and second sealing surfaces 43, 53 of the seal plates 42, 50, respectively, even if the first sealing element 200 is not symmetrically aligned with the second sealing element 202 about a longitudinal axis located between the two components. Additionally, the presence of a pin member 204 structurally independent of the first and second sealing elements 200, 202 allows the first and second sealing elements 200, 202 to independently move in the direction of arrows U, D, I and O of FIG. 3, in particular when the valve 10 is in the open position and only a portion of the first and second sealing elements 200, 202 overlie the first and second sealing elements, such that portions thereof are unsupported. In the prior art valve, the pin formed as an integral part of one of the first and second sealing elements 200, 202 could break off causing the valve to fail and require replacement, but here the forces causing that breakage do not impact the reliability and integrity of the shear seal assembly 36. In one embodiment, the pin member 204 may be right cylindrical in section such that in cross-section, the pin member is substantially circular. Alternatively, the pin member 204 could be of another shape, thereby altering the cross-sectional profile of the pin member. Additionally, the pin member 204 may be annular having a flow passage extending therethrough, and each of the first and second sealing elements 200, 202 include a flow passage 210 aligned therewith. In this case, fluid can flow through the shear seal assembly when the shear seal assembly blocks fluid from through bores 42, 50 from entering the interior volume of the valve 10.

The interior wall 208 of the first sealing element 200, the interior wall 214 of the second sealing element 202, the pin member 204, and the seal carrier 16 collectively define a channel 222 circumscribing the pin member. The sealing ring 400 is disposed between and contacts the first and second sealing elements 200, 202. More specifically, in the embodiments shown in FIGS. 3 and 4, the sealing ring 400 is within channel 222 and contacts the interior walls 208, 214 and is configured to bias the first and second sealing elements 200, 202 outwardly of the transverse bore 34. The sealing ring 400 circumscribes a portion of the pin member 204. More specifically, in the embodiment shown in FIGS. 1-4, the sealing ring circumscribes a central portion of the pin member 204.

The exterior walls 206, 212 of the shear seal assembly 36, in a free state before being assembled into the transverse bore 34 of the seal carrier 16, are spaced apart by a distance greater than the distance between the facing first and second sealing surfaces 43, 53 of the seal plates 42, 50 of the valve 10. Thus, when the shear seal assembly 36 is positioned in the transverse bore 34 of the seal carrier 16 and between the facing first and second sealing surfaces 43, 53 of the seal plates 42, 50, the sealing ring 400 is pre-compressed before any fluid under pressure is applied thereto.

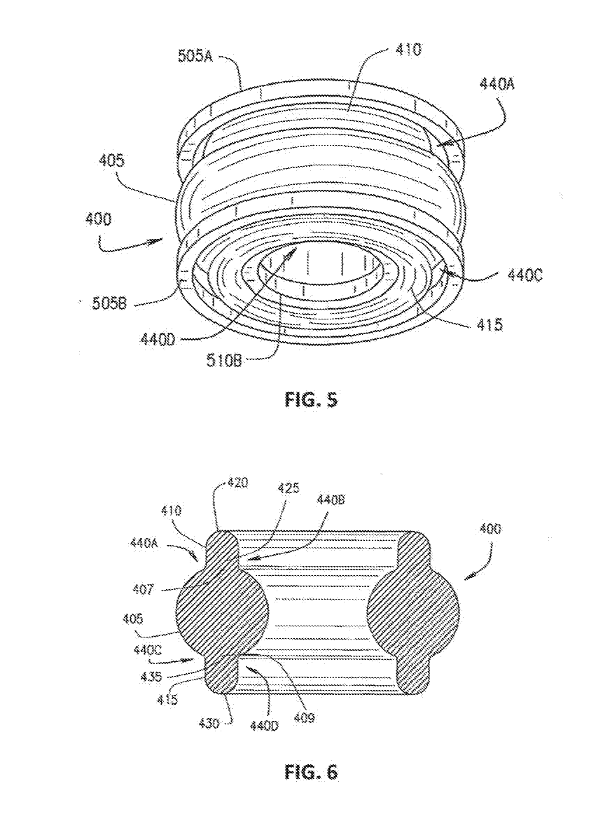

FIG. 5 illustrates an enlarged view of sealing ring 400. As shown in FIG. 5, sealing ring 400 is an annular key seal. It is to be understood, however, that an alternative type of seal may be employed in conjunction with the improved shear seal assemblies of the present disclosure other than an annular key seal (e.g., O-ring).

Sealing ring 400 includes a first circular seal portion 405 having a generally circular cross-sectional area. As can be seen in the cross-sectional view illustrated in FIG. 6, the first circular seal portion 405 has a first side 407 and a second side 409. The sealing ring 400 also includes a second rounded seal portion 410 and a third rounded seal portion 415. The second rounded seal portion 410 is positioned above the first circular seal portion 405, while the third rounded seal portion 415 is positioned below the first circular seal portion 405. Preferably, the second rounded seal portion 410 and the third rounded seal portion 415 have cross-sectional areas that are smaller than the cross-sectional area of the first circular seal portion 405.

The second rounded seal portion 410 has a first side 420 and a second side 425. In the embodiment shown in FIG. 6, the first side 420 of the second rounded seal portion 410 is rounded, while the second side 425 of the second rounded seal portion 410 is connected to the first side 407 of the first circular seal portion 405. The third rounded seal portion 415 has a first side 430 and a second side 435. In the embodiment shown in FIG. 6, the first side 430 of the third rounded seal portion 416 is rounded, while the second side 435 of the second rounded seal portion 415 is connected to the second side 409 of the first circular seal portion 405. As seen in FIGS. 5 and 6, an outer shoulder 440A and an inner shoulder 440B are formed about the connection between the second rounded seal portion 410 and the first circular seal portion 405. An outer shoulder 440C and an inner shoulder 440D are formed about the connection between the third rounded seal portion 415 and the first circular seal portion 405.

In the embodiment of the sealing ring 400 shown in FIGS. 5 and 6, the first, second, and third seal portions 405, 410, 415 are integrally formed. It is understood, however, that the first, second, and third seal portions 405, 410, 415 could be formed separately and later assembled into sealing ring 400. When not integrally formed, the first, second and third seal portions 405, 410, 415 could be permanently connected, or may be releaseably connected together such as via friction.

As discussed above, FIG. 3 illustrates an enlarged view of shear seal assembly 36. The arrows labeled FP indicate function pressure from a sample collection bottle or the transverse flow passage 38 communicating through the space between the outer circumferential surfaces 203, 213 of the first and second sealing elements 200 and the transverse bore 34 of the seal carrier 16, and thus into the channel 222 thereby urging sealing ring 400 into contact with pin member 204 and away from seal carrier 16. This will occur as the tool is removed from the wellbore and the ambient pressure surrounding the tool becomes lower than the pressure in transverse flow passage 38, which is at a sample pressure. Consequently, sealing ring 400 forms a seal against the pin member 204. As the sealing ring 400 presses against an exterior surface of the pin member 204, both the function pressure and the sealing ring 400 exert force against interior wall 208 of the first sealing element 200 and against interior wall 214 of the second sealing element 202. The force exerted on the interior walls 208, 214 by the function pressure and the sealing ring 400 creates a metal-to-metal seal between the first sealing element 200 and first sealing surface 43 of the seal plate 42, and between the second sealing element 202 and the second sealing surface 53 of the seal plate 50. At higher pressure, sealing between the first and second sealing elements 200, 202 and the respective seal plates 42, 50 is primarily due to forces exerted on the interior walls 208, 214 stemming from the function pressure. Additionally, the higher the pressure difference between the exterior of the downhole tool, i.e. the pressure in bores 44, 52, and the interior of the tool, i.e., the transverse flow bore 38, the greater the force exerted by the first sealing element 200 on the first sealing surface 43 of the seal plate 42, and by the second sealing element 202 on the second sealing surface 53 of the seal plate 50 to maintain the metal-to-metal seal.

In FIG. 4, the arrows labeled SP indicate supply pressure from wellbore fluids in bores 44, 52 as the downhole tool is being lowered to a sampling depth, and the pressure in transverse flow passage 38 is less than that in the bores 44, 52. Under these conditions, wellbore pressure communicates through flow passage 201 in sealing element 200, and through the space between pin member 204 and recess 210 and into the channel 222, thereby urging sealing ring 400 radially away from pin member 204 and against the internal surface of the transvers bore 34 of the seal carrier 16. Under these conditions, the pressure in the channel 222 and the bores 44, 52, and thus on the opposed sides of the sealing elements 200, 202, is the same, and the pre-compression of the sealing ring 400 is sufficient to maintain a metal-to-metal seal between the first sealing element 200 and the first sealing surface 43 of the seal plate 42, and between the second sealing element 202 and second sealing surface 53 of the seal plate 50, and thus prevent the fluid under pressure in the wellbore from prematurely entering the transverse flow passage and a sample bottle.

Thus, the shear seal assembly 36 is configured to seal against wellbore pressure higher than an interior pressure of the valve (transverse flow passage 38 pressure) flowing inwardly of the valve, and an interior pressure of the valve(transverse flow passage 38 pressure) greater than the wellbore pressure leaking from the valve. In particular, where the sample bottle is not separately isolated from the transverse flow passage, the shear seal assembly prevents loss of the fluid sample as the downhole tool is removed from the wellbore.

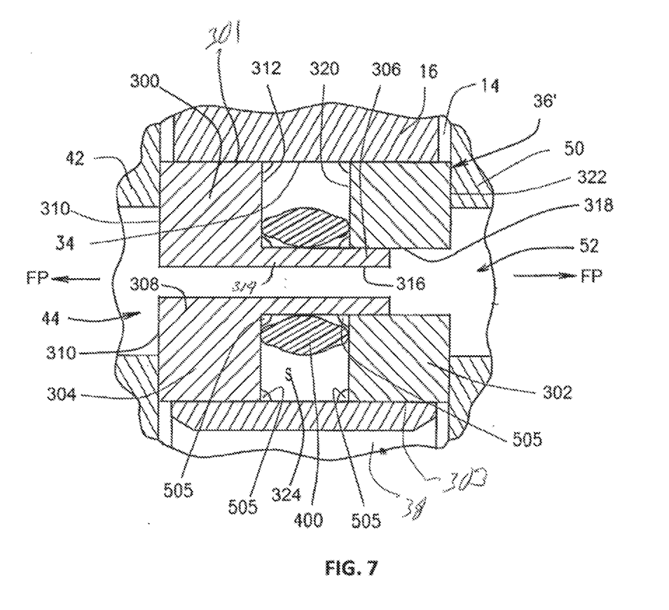

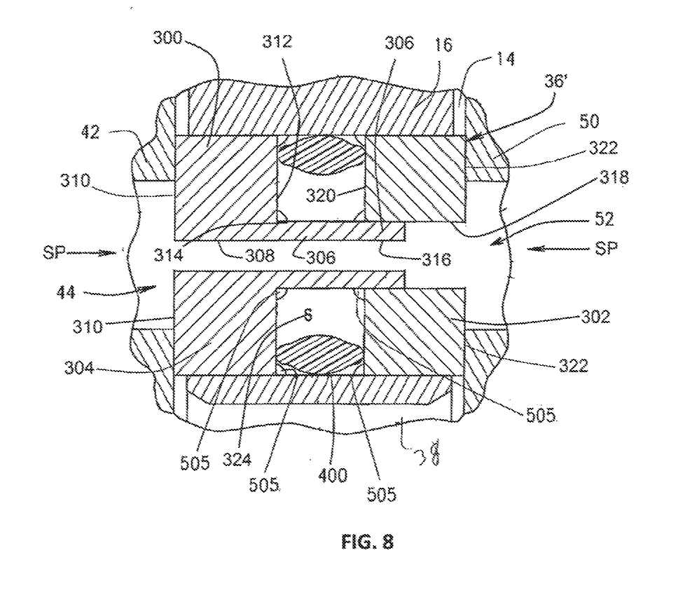

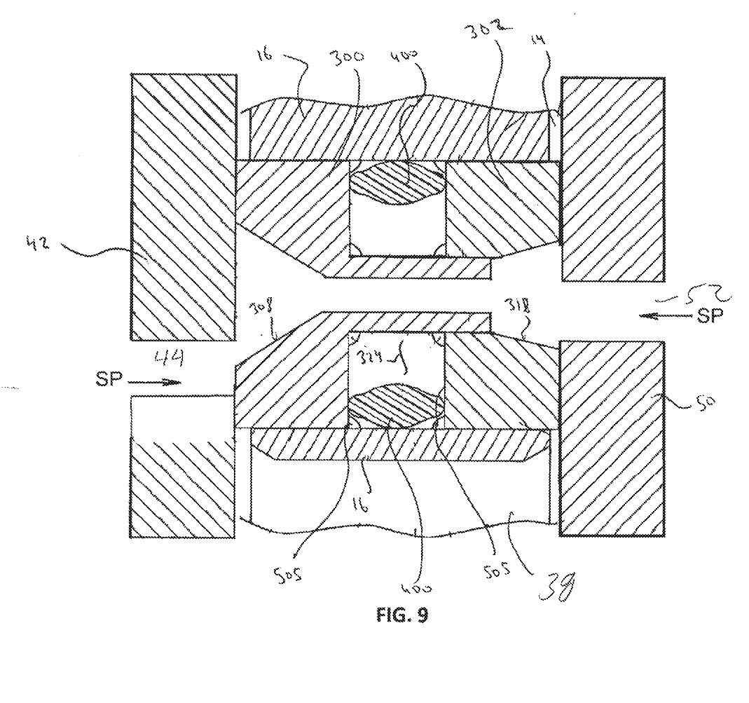

FIGS. 7 and 8 show an alternative embodiment of an improved shear seal assembly 36′. In FIGS. 7 and 8, shear seal assembly 36′ is disposed in a fluid valve similar to fluid valve 10. Shear seal assembly 36′ includes a first sealing element 300, a second sealing element 302, and a sealing ring 400. In contrast to the first embodiment, in this embodiment, the pin is formed integrally with one of the sealing elements, and also includes a bore extending therethrough. However, this embodiment may be modified to a construct similar to that of the first embodiment wherein the pin is formed separately from, and received in, recesses in the facing surfaces of the sealing elements 300, 302, and a flow passage aligned with the bore in the pin extend from the exterior surface of each sealing element 300, 302 into a corresponding recess. Thus, in the embodiment of a shear seal assembly 36′, a first sealing element 300 includes a block section 304, a pin section 306, and a bore 308. The block section 304 has an outer circumferential surface 301, an exterior wall 310 and an interior wall 312, and the pin section 306 has a first end portion 314 and a second end portion 316. The first end portion 314 is located adjacent the interior wall 312 of the block section 304 and the second end portion 316 is spaced therefrom inwardly of the shear seal assembly 36′. The bore 308 extends through the block section 304 and the pin section 306 to form a through-opening extending from the exterior wall 310 of the block section and through the second end portion 316 of the pin section 306. The bore 308 extends through a central portion of the block section 304 and the pin section 306. The second sealing element 302 includes an outer circumferential surface 303, an exterior wall 322, an interior wall 320 and a bore 318 extending therethrough and open at interior and exterior walls 320, 322, into which the second end 316 of the pin section 306 extends with a clearance on the order of 1 to 5 thousands of an inch therebetween.

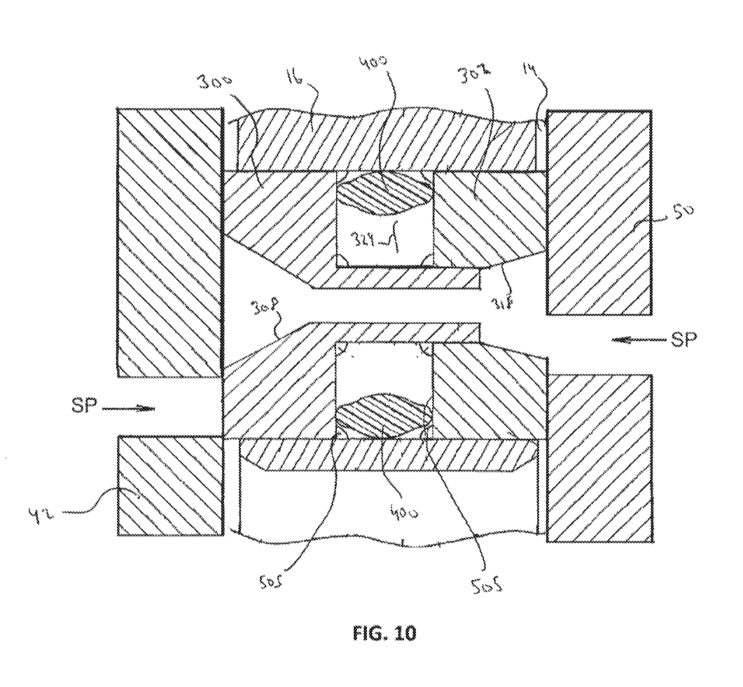

Alternatively, as shown in FIGS. 9 and 10, bore 308 of the first sealing element 300 can have tapered walls within block section 304 such that the opening of bore 308 is larger at the exterior wall 310 of the block section and smaller at the second end portion 316 of the pin section 306. Similarly, bore 318 of the second sealing element 302 can have tapered walls such that the opening of bore 318 is larger at the exterior wall 322 and smaller at the interior wall 320. Tapering the walls of bore 308 and bore 318 can be particularly useful when fluid inlets in a valve are staggered (i.e., not axially aligned), as shown in FIGS. 9 and 10, or when the valve functions as a three or four-way valve, and two fluid inlets extend through at least one of the seal plates, and the first and second sealing elements can be positioned to selectively allow one, both, or neither of the fluid inlets to communicate into the through bore therein. By tapering the walls of bores 308, 318, seal carrier 16 can position shear seal assembly 36′ such that fluid from the staggered fluid inlets can flow through both bore 308 and bore 318. Additionally, the tapered walls of bores 308, 318 minimize the distance the seal carrier 16 must travel to adjust the fluid valve between open configuration (shown in FIG. 9) and the closed configuration (shown in FIG. 10) when the opening s are offset. FIG. 9 shows the valve (exposed to supply pressure) in an open position in which fluid can pass through the bores 308, 318 and into the transverse flow passageway 38 of the valve. FIG. 10 shows the valve (exposed to supply pressure) in a closed position such that fluid cannot pass through the bores 308, 318 and into the transverse flow passage 38 of the valve. It is to be understood that rather than having tapered walls, bores 308, 318 could alternatively be countersunk. Alternatively, only one of the bores 308, 318 may be tapered or countersunk.

In FIGS. 7 and 8, shear seal assembly 36′ is positioned in the transverse bore 34 of the fluid valve such that the exterior wall 310 of the block section 304 of the first sealing element 300 is in contact with and seals against the first sealing surface 43 of the seal plate 42, and the exterior wall 322 of the second sealing element 302 is in contact with and seals against the second sealing surface 53 of the seal plate 50. The first and second sealing elements 300, 302 are positioned relative to each other such that the bore 318 of the second sealing element 302 receives the second end portion 316 of the pin section 306 therein. Moreover, the first and second sealing elements 300, 302 are oriented such that interior wall 312 faces interior wall 320. As discussed above, the sealing ring 400 may be a key seal as shown in channel 324. Alternatively, sealing ring 400 could be an alternative seal type. In each case, the sealing ring is pre-compressed to enable sealing of the wellbore fluid from the internal volume of the valve, as with the valve 10 of the first embodiment.

In shear seal assembly 36′, the interior wall 312 of the block section 304 of the first sealing element 300, the pin section 306, the interior wall 320 of the second sealing element 302, and the seal carrier 16 collectively define a channel 324 circumscribing the pin section. The sealing ring 400 is disposed between and contacts the first and second sealing elements 300, 302. More specifically, in the embodiments shown in FIGS. 7 and 8, the sealing ring 400 is located within channel 324 such that the sealing ring contacts interior wall 312 of the first sealing element 300 and interior wall 320 of the second sealing element 302. The sealing ring 400 circumscribes a portion of the pin section 306 of the first sealing element 300. More specifically, in the embodiment shown in FIGS. 7 and 8, the sealing ring 400 circumscribes a central portion of the pin section 306.

As can be seen in FIGS. 7 and 8, when the pin section 306 of the first sealing element 300 is received within the bore 318 of the second sealing element 302, a fluid passageway is formed that extends from the exterior wall 310 of the block section 304 of the first sealing element 300 to the exterior wall 322 of the second sealing element 302. If shear seal assembly 36′ is exposed to a source of non-uniform pressure such that pressure through inlet port 46 would otherwise be less than or greater than pressure through inlet port 50, the fluid passageway allows fluid to flow through the shear seal assembly 36′ to enable the pressures to become more balanced. Additionally, the construct of the shear seal assembly 36′ creates a valve which, in other applications, can allows fluid to electively flow through the shear seal assembly 36′ from one exterior wall 322 to the opposed exterior wall 310 based on the relative position of the valve and the sealing elements 300, 302 to fluid passages adjacent thereto in the seal plates 42, 50, and selectively allow communication between one or more such fluid passages in the seal plate to a volume adjacent to the shear seal assembly 36′.

FIG. 7 illustrates an enlarged view of a shear seal assembly 3′ in a fluid valve 10, when the exterior pressure, in this case, the well bore pressure, is less than an internal pressure of the valve, such as a sample bottle of transverse flow passage 38 pressure. The arrows labeled FP indicate function pressure from a sample collection bottle or the transverse flow passage 38 passing between the outer circumferential surfaces 310, 303 of the sealing elements 300, 302 and the transverse bore 34 of the carrier 16 and into the channel 324, thereby urging sealing ring 400 into contact with pin section 306 and away from seal carrier 16. Consequently, sealing ring 400 forms a seal against the pin section 306. As the sealing ring 400 deforms against an exterior surface of the pin section 306, both the function pressure and the deformed sealing ring 400 exert force against interior wall 312 of the block section 304 of the first sealing element 300. Function pressure and the deformed sealing ring 400 further exert force against interior wall 320 of the second sealing element 302. The force exerted on the interior walls 312, 320 by the function pressure and the sealing ring 400 creates a metal-to-metal seal between the first sealing element 300 and first sealing surface 43 of the seal plate 42, and between the second sealing element 302 and the second sealing surface 53 of the seal plate 50. At higher differential pressures, sealing between the first and second sealing elements 300, 302 and the respective seal plates 42, 50 is primarily due to forces exerted on the interior walls 312, 320 stemming from the function pressure, and the sealing force between the first sealing element 300 and first sealing surface 43 Of the seal plate 42, and between the second sealing element 302 and the second sealing surface 53 of the seal plate 50 increases, ensuring sealing of the functional pressure fluid within the valve.

In FIG. 8 shows the valve when the internal pressure of the valve is less than the pressure exterior thereto, such as when the downhole tool is being raised out of the wellbore. In FIG. 8, the arrows labeled SP indicate supply pressure from wellbore fluids communicating through bore 44 in the seal plate 42 and bore 52 in seal plate 50 and in the small gap between the pin member 306 and the bore 318 in the second sealing element 320 and thus into the channel 324, thereby urging sealing ring 400 radially away from pin section 306 and against the seal carrier 16. Additionally, the pressure in the channel 324 and the pressure in the bores 44, 52 are the same, and thus the pressure on either side of the sealing elements 300, 302 is the same, i.e., the pressure is balanced. As a result, the well bore pressure does not tend to compress the sealing ring 400, and the pre-compression on the sealing ring 400 creates a metal-to-metal seal between the first sealing element 300 and first sealing surface 43 of the seal plate 42, and between the second sealing element 302 and the second sealing surface 53 of the seal plate 50. This is maintained irrespective of the exterior pressure on the valve because the pressure is balanced across the sealing elements 300, 302 when the exterior pressure of the wellbore exceed the interior pressure in the valve.

Thus, the shear seal assembly 36′ is configured such that the sealing ring 400 prevents wellbore fluid from flowing through the channel 324 in a longitudinal direction substantially perpendicular to the arrows FP and SP in FIGS. 7 and 8 when the shear seal assembly is alternatively exposed to one of a function pressure and a supply pressure. Additionally, the shear seal assembly 36′ is configured such that the sealing ring 400 urges the first and second sealing elements 300, 302 away from each other in a direction substantially perpendicular to the longitudinal direction, thereby maintaining the metal-to-metal seal between the first sealing element 300 and seal plate 42 and between the second sealing element 302 and seal plate 50.

As shown in FIGS. 3 and 4 showing shear seal assembly 36 and FIGS. 7 and 8 showing shear seal assembly 36′, one or more back-up rings 500 may also be positioned in channel 222 or channel 324 to prevent extrusion of the sealing ring 400. Back-up rings 500 may be positioned proximate each of the shoulders 440A-440D of the sealing ring. In such an embodiment, back-up rings 500 may have a generally triangular cross-sectional area radiused toward the proximate shoulder of the sealing ring 400. It is to be understood, however, that back-up rings 500 with other cross- sectional shapes may also be used. Back-up rings may be made of PEEK (poly-ether-ether-ketone).

If an alternative sealing ring is used, back-up rings may be positioned at proximate junctions between components of shear seal assembly 36 or shear seal assembly 36′ that are moveable with respect to one another. For example, in shear seal assembly 36, back-up rings 500 may be positioned proximate the junctions between the interior wall 208 of the first sealing element 200 and seal carrier 16 and between the interior wall 214 of the second sealing element 202 and seal carrier 16. Additionally, back-up rings may be positioned proximate the junctions between the interior wall 208 of the first sealing element 200 and pin member 204 and between the interior wall 214 of the second sealing element 202 and pin member 204.

A shear seal assembly as disclosed herein is not limited to use in a fluid valve as disclosed. As is evident from the foregoing description, certain aspects of the present disclosure are not limited by the particular details of the examples illustrated herein, and it is therefore contemplated that other modifications and applications, or equivalents thereof, will occur to those skilled in the art. Changes, modifications, variations and other uses and applications of the present disclosure will, however, become apparent to those skilled in the art after considering the specification and the accompanying drawings. All such changes, modifications, variations and other uses and applications which do not depart from the spirit and scope of the disclosure are deemed to be covered by the disclosure which is limited only by the claims which follow.

1. A shear seal assembly positioned in a transverse bore of a seal carrier in a valve, the seal carrier capable of shifting from a closed position to an open position, the valve including a pair of opposed seal plates, the shear seal assembly being aligned with the seal plates when the seal carrier is in the closed position and the shear seal assembly being out of alignment with the seal plates when the seal carrier is in the open position, the shear seal assembly comprising:
a pin member including a first end portion and a second end portion;
first and second sealing elements, the first sealing element being in contact with and sealing against one seal plate, the second sealing element being in contact with and sealing against the other seal plate, each of the first and second sealing elements including a recess, the first end portion of the pin member being within the recess of the first sealing element and the second end portion of the pin member being within the recess of the second sealing element such that the pin member is between the first and second sealing elements;
a sealing ring disposed between and contacting the first and second sealing elements, the sealing ring circumscribing a portion of the pin member.

2. The shear seal assembly of claim 1 wherein the sealing ring includes:
a first seal portion having a generally circular cross-sectional area, the first seal portion having a first side and a second side;
a second, rounded, seal portion having a first side and a second side, the second side of the second rounded seal portion connected to the first side of the first seal portion, and the second rounded seal portion having a cross-sectional area which is smaller than the cross-sectional area of the first circular seal portion;
a third, rounded, seal portion having a first side and a second side, the first side of the third rounded seal portion connected to the second side of the first seal portion, and the third rounded seal portion having a cross-sectional area which is smaller than the cross-sectional area of the first circular seal portion.

3. The shear seal assembly of claim 2 wherein the first side of the second rounded seal portion is in sealing contact with the first sealing element and the second side of the third rounded seal portion is in sealing contact with the second sealing element.

4. The shear seal assembly of claim 1 wherein the assembly further comprises a channel defined by the first and second sealing elements, the sealing ring located within the channel, and the shear seal assembly being configured such that the sealing ring prevents fluid from flowing through the channel in a first direction and urges the first and second sealing elements away from each other in a second direction, the first direction being substantially perpendicular to the second direction.

5. The shear seal assembly of claim 4 wherein the channel is further defined by the pin member and the seal carrier, and the assembly further includes first and second back-up rings within the channel, the first and second back-up rings positioned to prevent extrusion of the sealing ring from the channel.

6. The shear seal assembly of claim 1 wherein the sealing ring deforms radially inward against the pin member when the shear seal assembly is exposed to function pressure and the sealing ring deforms radially away from the pin member against the seal carrier when the shear seal assembly is exposed to supply pressure.

7. The shear seal assembly of claim 1 wherein the pin member is moveable within the recesses of the first and second sealing elements.

8. A shear seal assembly positioned in a transverse bore of a seal carrier in a valve, the seal carrier capable of shifting from a closed position to an open position, the valve including a pair of opposed seal plates, the shear seal assembly being aligned with the seal plates when the seal carrier is in the closed position, and the shear seal assembly being out of alignment with the seal plates when the seal carrier is in the open position, the shear seal assembly comprising:
a first sealing element having a block section, a pin section, and a bore therein, the pin section extending from the block section, the bore of the first sealing element extending through the block section and the pin section, the block section being in contact with and sealing against one seal plate;
a second sealing element having a bore therein, the bore of the second sealing element receiving at least a portion of the pin section of the first sealing element therein, the second sealing element being in contact with and sealing against the other seal plate;
a sealing ring disposed between and contacting the first and second sealing elements, the sealing ring circumscribing a portion of the pin section of the first sealing element.

9. The shear seal assembly of claim 8 wherein the sealing ring includes:
a first seal portion having a generally circular cross-sectional area, the first seal portion having a first side and a second side;
a second, rounded, seal portion having a first side and a second side, the second side of the second rounded seal portion connected to the first side of the first seal portion, and the second rounded seal portion having a cross-sectional area which is smaller than the cross-sectional area of the first circular seal portion;
a third, rounded, seal portion having a first side and a second side, the first side of the third rounded seal portion connected to the second side of the first seal portion, and the third rounded seal portion having a cross-sectional area which is smaller than the cross-sectional area of the first circular seal portion;
wherein the first side of the second rounded seal portion is in contact with the first sealing element and the second side of the third rounded seal portion is in contact with the second sealing element.

10. The shear seal assembly of claim 9 wherein the assembly further comprises a channel defined by the first and second sealing elements and the seal carrier, the sealing ring located within the channel, the shear seal assembly configured such that the sealing ring prevents fluid from flowing through the channel in a first direction and urges the first and second sealing elements away from each other in a second direction, the first direction being substantially perpendicular to the second direction.

11. The shear seal assembly of claim 10 wherein the assembly further includes first and second back-up rings within the channel, the first and second back-up rings positioned to prevent extrusion of the sealing ring from the channel.

12. The shear seal assembly of claim 8 wherein the sealing ring deforms radially inward against the pin section of the first sealing element when the shear seal assembly is exposed to function pressure and the sealing ring deforms radially away from the pin section of the first sealing element when the shear seal assembly is exposed to supply pressure.

13. A seal assembly, comprising:
a first sealing element having a recess formed therein, an interior wall of the first sealing element surrounding the recess therein;
a second sealing element having a recess formed therein, an interior wall of the second sealing element surrounding the recess therein, the first and second sealing elements being oriented such that the interior wall of the first sealing element faces the interior wall of the second sealing element;
a pin member having a first end portion and a second end portion, the first end portion of the pin member located within the recess of the first sealing element and the second end portion of the pin member located within the recess of the second sealing element, the pin member movable within the recesses of the first and second sealing elements, the interior wall of the first sealing element being spaced from the interior wall of the second sealing element to define a channel circumscribing the pin member; and
a sealing ring located within the channel, the sealing ring contacting the interior walls of the first and second sealing elements.

14. The seal assembly of claim 13 wherein the pin member is annular in cross-section.

15. The seal assembly of claim 13 wherein the assembly further comprises a seal carrier, and the channel is further defined by the pin member and the seal carrier.

16. The seal assembly of claim 15 wherein the first and second sealing elements are oriented in a manner such that the sealing ring seals the channel to prevent fluid from flowing through the channel in a first direction while also urging the first and second sealing elements away from each other in a second direction, the first direction substantially perpendicular to the second direction.

17. The seal assembly of claim 13 wherein sealing ring includes:
a first seal portion having a generally circular cross-sectional area, the first seal portion having a first side and a second side;
a second, rounded, seal portion having a first side and a second side, the second side of the second rounded seal portion connected to the first side of the first seal portion, and the second rounded seal portion having a cross-sectional area which is smaller than the cross-sectional area of the first circular seal portion;
a third, rounded, seal portion having a first side and a second side, the first side of the third rounded seal portion connected to the second side of the first seal portion, and the third rounded seal portion having a cross-sectional area which is smaller than the cross-sectional area of the first circular seal portion.

18. The seal assembly of claim 17 wherein the first side of the second rounded seal portion is in sealing contact with the interior wall of the first sealing element and the second side of the third rounded seal portion is in sealing contact with the interior wall of the second sealing element.
